(19) United States
(12) Patent Application Publication
(10) Pub. No.: US 2010/0176248 A1
(43) Pub. Date: Jul. 15, 2010

(54) SPACECRAFT PROPULSION SYSTEM WITH GYROSCOPIC MECHANISM

(76) Inventor: Mehmet Terziakin, Bakirkoy Istanbul (TR)

Correspondence Address: Mehmet Terziakin, Incirli Cad Gulbahce Sok 16/1, Bakirkoy Istanbul PK, 34457, TR

(21) Appl. No.: 12/452,971

(22) PCT Filed: Sep. 28, 2008
(86) PCT No.: PCT/TR2008/000116

§ 371 Date: Feb. 1, 2010

(30) Foreign Application Priority Data
Sep. 28, 2007 (TR) 2007/06725

(51) Int. Cl. B64C 39/00; B64G 1/40

(52) U.S. Cl. 244/171.3; 244/171.5; 244/62

(57) ABSTRACT

A propulsion method employing gyroscopes (1,2) with electric motors (4) which are being moved along a closed path in the spacecraft. Rotation axis of the gyroscopes are rotated periodically relative to movement direction so that gyroscopic effect is only obtained during movement in one direction. Thereby a gyroscopic resistance difference is obtained and used as a propulsion force. Another application is to use gyroscopes connected to generators in order to decelerate a spacecraft, transforming the moment created in gyroscope during deceleration into the electrical energy, distribute it to the space as heat transfer by means of radiation through the heat resistant panels.

The invention relates to a system for developing propulsion and deceleration forces for spacecrafts by using gyroscopic effect.

The impulse system used in spacecrafts is primarily the rocket motors. As to landing to the Earth or any other planet already possesses an atmosphere, the parachute deceleration system could be used after decelerated sufficiently for landing. In order to escape completely from Earth's gravity, the widespread system is to use an propulsion system involving multi-stage rockets. The primary stage rockets carry not only the main mass which will poke out to space, but also the other rocket stages which even have greater mass. Rocket stage running out of fuel is separated from the main system and fall to Earth and the next stage is ignited. The main load to be carried constitutes only a small part of the total mass of the rocket during the first take off. Similarly, the spacecrafts soaring into space or put into orbit around the Earth have rocket motors, used for purposes such as orbit adjustment. The efficiency of this system is quite low due to the fact that rocket fuel and caustic material for propulsion are also carried by the rocket.

Considering the low efficiency of such propulsion systems, other alternatives have been searched for a long time. Gyroscopic propulsion systems are also among the alternatives that are being searched thoroughly. Despite the abundance of granted patents to be used for this effect, there is not yet any system that might prove to yield effective results.

The invention will be applicable in 2 ways. The version that is simpler and easier in application among these two is the one which will be used to decelerate the spacecraft in a gravitational field. The other one is that to allow propulsion to the spacecraft.

Vehicle deceleration system, in principle, is a system involving one or more flywheels with a rotational axis angular to—not parallel to—preferably perpendicular to the system's movement direction. Here, in principle, a resistance is generated by the gyroscopic effect against the movement by means of rotating such gyroscope(s). Rotation of such a gyroscope in a rapidly moving spacecraft will cause an increase in the rotation number of gyroscope and creation of a moment in the direction of the increase. Practically this effect will be very severe in a spacecraft moving with a speed of 40.000 km per hour. The presented solution concerning the system is to employ an electricity generator fitted to the gyroscope shaft and transforming the moment created into electricity in the generator. Discharging such energy in an harmless way will be implemented by heating a group of heating panels which face to the space by means of resistances and distributing the generated heat to space by radiation. Here, it is highly critical to control the momentum and direction of deceleration while the spacecraft is descending for landing. This control will be achieved by adjusting speed and direction of the gyroscope, the resistance created in the generator against rotation-moment value and the direction of the rotational axis.

In case that the system is used as a movement source to provide impulse to the spacecraft, the most ideal energy source for the energy feeding will be the solar energy. For this purpose either solar panels or a thermodynamic cycle utilizing solar energy can be used. When a spacecraft is taking off from the land by means of this method, a turbine or a piston engine can be used up to the height where oxygen can be supplied through atmosphere. In this case, the fuel will be carried in the carrier system and the oxygen will be taken from air. This will outclass with respect to the rockets which also have to carry the oxygen. At heights where stable wind speed is available such as stratosphere, wind turbines connected to the system could also be a convenient energy source. This will be a specific speed difference from the speed of the wind due to system's resistance to the movement caused by the gyroscopes. Considering that the speed of the wind at stratosphere is about 120 kms per hour and that the speed of the wind energy is in directly proportional with its cube, it can be understood that there is an important energy potential which the system can make use of while passing through these layers of the atmosphere

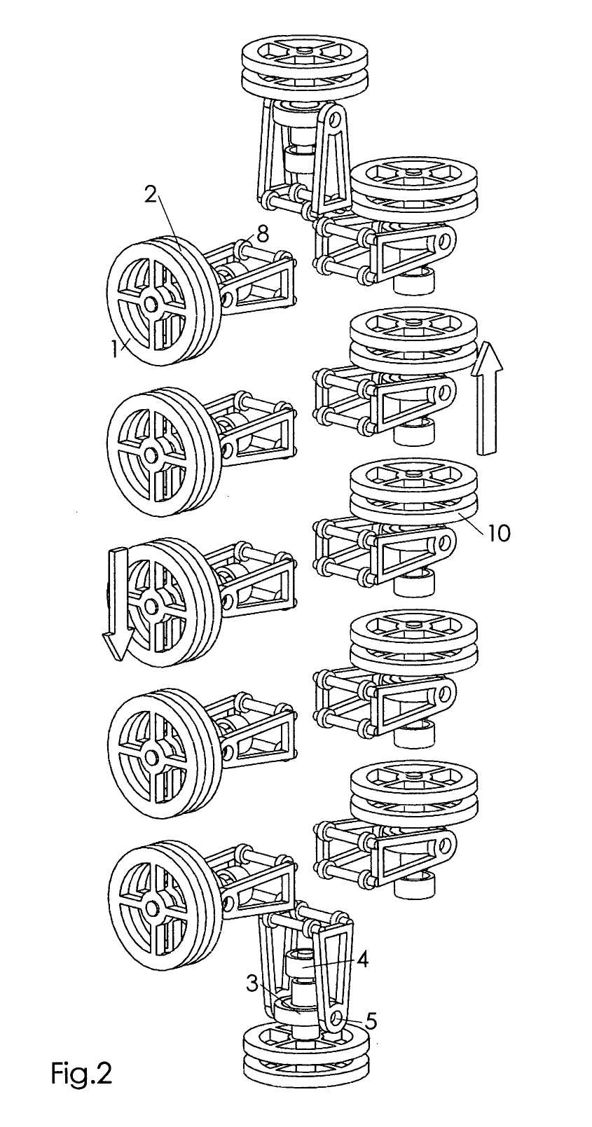

During the initial take off from the land, electricity feeding from the ground is also a convenient option. Since the length of conductor cannot exceed particular values, using these gyroscopic carrier units, placed at every two kilometers for instance, could overcome the conductor split-off because of its own weight. In this case, while the carrier platform is rising, for example when it raised up for a certain length, a conductive carrier gyroscopic rising system will be connected to the conductor and the over-tensions in the conductor will be prevented. Such conductive rising systems will also be systems working as per the principle indicated in FIG. 2, getting energy from the conductor it carries but having relatively smaller dimensions with respect to the main system.

In cases where solar electric panels are used, a mechanical system should be used in order to direct them towards the sun. There are various difficulties to keep such panels at specific directions when there are severe winds at the lower layers of the atmosphere. But in space conditions this will be relatively easier. However when solar energy is used, the energy will be cut at night. In this case, the possible option could be that the system stays in the air during the night by descending slightly. As the system has a specific limit speed, the distance of descent will be limited. On the other hand, by collecting the kinetic energy or electricity accumulated in the gyroscopes in the accumulator the distance of descent can be decreased or a rise can be possible. Another option is arranging to pass through those heights where there are severe winds in the atmosphere during the night and using wind as the energy source at night. This system, in practical applications, should also be operated in the way to move horizontally for a certain distance against scudding.

If this propulsion system will be used to orbit an satellite, a mass containing the satellite and the rocket is raised to the required height by the system. As it is not possible for such a system to be able to reach high velocities while the gravitational field of Earth is in effect, it is accelerated to the speed required for orbiting the Earth by igniting the rocket at appropriate altitude. As this system is to constitute a constant mass in this case, acceleration by using a system involving electromagnetic cannons or some acceleration mechanism, or a cannon of chemical explosives are of the significant options for accelerating a satellite without using any rocket fuel or using it just in limited quantity. In this case this acceleration system will be performed as a part of the rising platform.

One of the most important superiorities of this system is that there is no deceleration effect for gyroscopes in the positions where there is no important gravitational field. Under these conditions the system can accelerate gradually in a stable way. For example during spacecraft travels to the outside of solar system, the system can reach to enormous speeds as it doesn't need rocket fuel.

As an energy source, it will be appropriate to use a nuclear energy as the heat source as the heating source whereas space will be used for discharging waste heat by radiation.

The systems defined here can also be used in aviation. Especially they can be used for air vehicles which take off vertically and afterwards fly as an airplane (VSTOL) for taking off, reaching up to a certain height and then flying as an airplane. For this purpose, the system can be operated by means of two gyroscopic mechanisms which will come out from the body of the airplane and be raised up to a certain height by means of a telescopic mechanism.

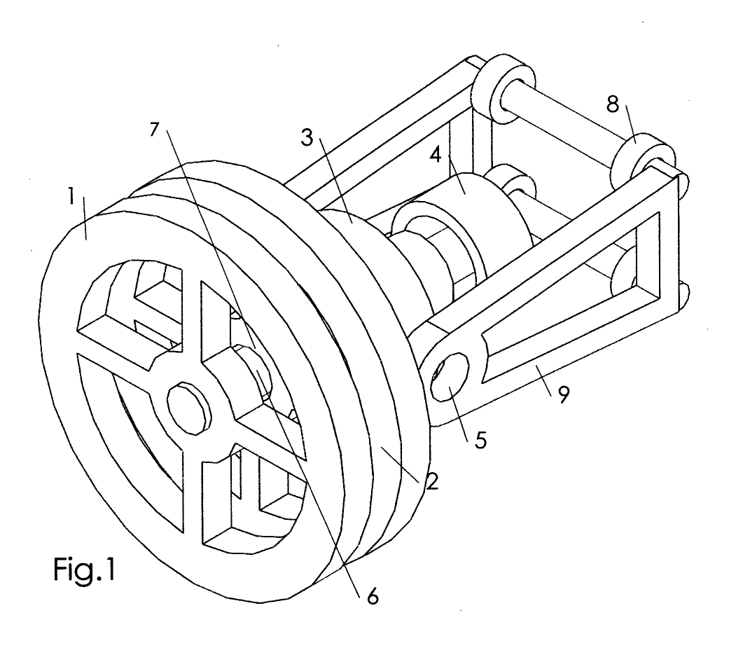

FIG. 1 is the basic system which will be used both for the propulsion and deceleration.

FIG. 2 is a perspective view of the structure of the rising-climbing towing vehicle to be used for spacecrafts.

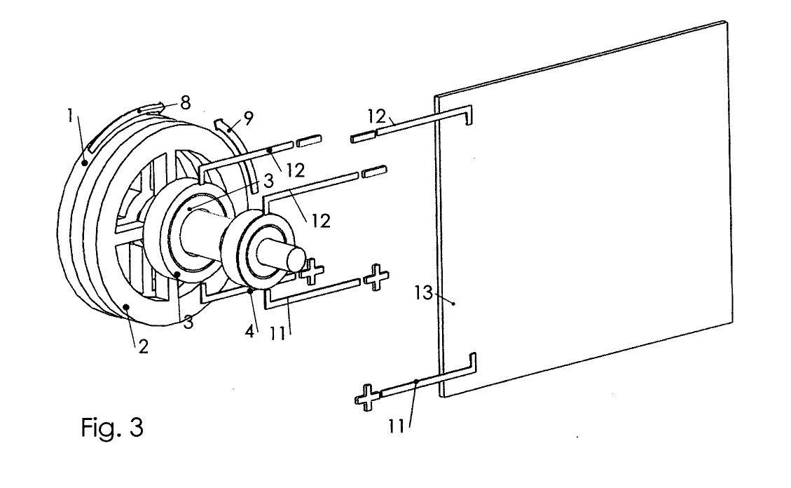

FIG. 3 shows a drawing of a system to be used as a brake which will decelerate vehicles and especially spacecrafts.

In FIG. 1, the basic unit of the system, the mechanism containing gyroscope is shown. Here two gyroscopes working back to back and rotating in opposite directions have been used. The shaft (6) of the gyroscope 1 passes through the hollow shaft (7) of the gyroscope 2. The electric motor (4) which rotates the gyroscope is located on the shaft (6) of the gyroscope 1. There is another electrical motor (3) located on the shaft of the gyroscope 2.

This flywheel pair can be rotated in vertical or horizontal positions by means of a hinge (5). In order to move this gyroscope pair, it should be forced strongly when its rotation axis is perpendicular to movement direction. In order to generate a lift force by using this invention, the gyroscopes are moved along a closed path relative to the spacecraft body. During this movement rotation axis of the gyroscope is changed relatively to the desired propulsion vector. Gyroscopes generate a gyroscopic resistance against movement when its rotation axis is not parallel to its own movement axis. Increasing the angle between its rotation axis and movement direction increases the resistance against movement. During periodical movement of such a gyroscope along its closed travel path, its rotation axis is changed periodically relative to the movement direction. For example, these gyroscopes can be jointed around a main rotating wheel. The gyroscopes and the main wheel are rotated and the rotation axis of gyroscopes are changed periodically depending on the upward and downward movement direction, so that while gyroscopes are moving down, their axis become horizontal at the left hand side of the main wheel,and while they are moving up their axis they become vertical and parallel to the movement vector at the right side of the wheel. This system causes a substantial upward force or a lift force at the wheel hub. This force generates a reaction force with opposite direction at the hinge. By means of Hinge (5), Gyroscopes (1, 2) and the motors (3,4) and bearings on them can be placed in vertical or horizontal positions. These mechanisms are moved up an down on wheels (8) placed one after the other like chain. The feeding of electrical engines (3, 4) operates on a structure not shown in the figure which obtains the energy from the rails on which the wheels (8) move or obtains the energy through a conductor which contacts to a rail separately. Rotation speeds of the gyroscopes and their setting to vertical or horizontal positions are provided by moving it by means of a controller and hinge (5) actuating mechanism that are not shown in the figure taking place in these units. By means of using a rail as cam profile other than those rails on which the wheels rotated through the hinge are going (not shown in the figure), the gyroscopes 1, 2 can be rotated through the hinge (5) by a mechanism which follows such cam profile of said rail. This will be a simple and efficient mechanism. In order not to make the figure complicated, these details aren't shown.

In FIG. 2 operation of the system is shown. The gyroscope units in FIG. 1 are going down to the left side, turning to the lower right side at the bottom of the rails and going up on the right. The gyroscopes are rotating around their horizontal axis on the units that can be seen going down on the left side. On the right side, whereas it changes direction on the hinge in the way that the rotation axis also to be vertical while going up. On the upper and lower sides the rails are semicircular forming a structure around which these units rotate. When gyroscopes are impulsed down their rotational axis are also horizontal. In such case gyroscopes need to be pressed strongly in order to impulse them down. On the right side, rotational axis of the units that goes up is also in upwards direction, i.e. parallel to their movements. For example, when a gyroscope unit is going down in this way, it will be impulsed with 100 kN reaction force acted on the chain whereas 10 kN force will be sufficient to rise it up while going up. On the left side while the gyroscopes are going down they should have a certain absolute downstream speed. This means that as far as going down to a certain distance is concerned as an absolute speed this will require important forces to press the gyroscopes down and this will signify a lifting force for the entire system as well. There is a motor-driven movement mechanism, not shown on the figure, which allows the rotational movement of these gyroscope around the system These units which are connected consecutively will be rotated by means of wither a chain mechanism or steel ropes or belts. In this case, an engine redactor group connected to a chain gear at the top or at the bottom will be used. This isn't shown either in order not to make the figure complicated.

As described above the pressure force to be applied while the gyroscopes, for instance, are rotating around the horizontal axis and being pressed downwards at a certain speed and the upwards force to be applied when it is made parallel to the movement direction of the rotational axis by means of moving to the right side of the ferris wheel while being driven will be highly different. Therefore the gyroscopes should be produced in a structure allowing the weights to be focused at the farthest possible point from the axis and a high gyroscope diameter as well as a greater number of revolutions. Provided that high speed DC motors and preferable brush less motors are used for actuating the gyroscopes, thereby rotation speed higher than 10.000 revolutions per minute can be easily possible. Under these conditions it is possible to produce very efficient gyroscopes by means of the mechanism described here and to obtain great differences in the conditions of the right side and left side of the mechanism shown in FIG. 2 in terms of the propulsion force of the units. In such a mechanism employing an electric motors for rotating gyroscopes is not an obligation and another mechanism to rotate gyroscopes can also be preferred. This structure can provide a highly productive propulsion in comparison with the current propulsion systems. These gyroscopes can also be rotated around a circle. In circular movement, for example, the rotational axis of the gyroscopes going down is kept horizontal whereas the rotational axis of those going up are kept vertical so that a substantial difference in between these reaction forces allows a propulsion force acted on circle hub.

In this way big lifting forces can be generated in the system. A spacecraft that will be connected to this system can be lifted towards the space by means of using solar panels on the ground or other energy sources mentioned above. Thus, this system will be used as a rising platform that has the ability to climb to the space or sky. Especially when energy sources like nuclear energy or solar energy is used, it will become very easy to send loads such as satellites to the space.

Considering that the system will be able to move at very low speeds under the effect of gravity, a raised spacecraft or a satellite for instance should be accelerated again by a rocket and orbited or should start traveling in the space by being accelerated by means of a rocket upon arrival to the space. Rising, in this case will not only allow eliminating the usage of a rocket for going out to the atmosphere and taking bigger loads to the space but also an easier exit from the gravitational field of Earth due to the descending gravity when become distant from Earth.

In FIG. 3 the simplest operation of the system is shown. Here the property of forming resistance against the movement by means of a gyroscopic effect will be used to decelerate a vehicle, especially a spacecraft. Gyroscopes (1) and (2) are the gyroscopes which are made in the way to provide a great area idleness having the mass focused in the periphery. In the structure shown in this figure, two gyroscopes 1 and 2 are rotated on the opposite directions to each other. Its reason is to have the opposite moments, which will be created by the gyroscopes in the bearings and generators, balance each other. The shaft of the gyroscope 1 is hollow from where the shaft (5) of gyroscope (2) passes through. Rotors (3,4) of the electricity generators/engines are connected to these shafts. And stators are connected at a fixed position around them. Here frictionless or magnetic bearing can be used. These motors/generators are preferably high speed direct current engines. During the initial start up they are operated as motors and the gyroscopes are started. Rotational axis of gyroscopes is placed angular and preferably in perpendicular angle to the movement direction of the spacecraft. In order to control the resistance of this system against movement, the rotational axis of the shafts can also be rotated slightly. In case that there is perpendicular angle against the movement the highest resistance will be generated whereas in case of an acute angle the resistance of the gyroscope against the movement will be decreased. On the other hand, increasing and decreasing the currents of the efficient magnetic area to be used in the electricity generators is another parameter that can be used in controlling.

When the spacecraft is with the gravitational field of a celestial body and would like to slow down these gyroscopes are rotated. For the initial start up the generators are operated in the electrical engine mode. Here it will be appropriate to use high revolution direct current engines with continuous magnets.

A very important point to mention here is that, in case of a rapid rotation of such a gyroscope in a spacecraft moving at a high speed, the resistance against movement that is generated by the gyroscope emerges a strong tendency of increase in the speed of the gyroscope. Thus, existence of a high absolute speed, a high gyroscope speed and gravitational field all together at the same time will emerge a strong tendency to slow down at the spacecraft. The decrease of speed and kinetic energy of the spacecraft will cause increase in the kinetic energy of gyroscopes (1) and (2) (or in many more gyroscopes that work in the similar way). Preferably magnetic bearings are employed in these gyroscopic propulsion systems. The most important point here is how this kinetic energy will be discharged to the space in a harmless way and how the gyroscope speeds will be maintained at a certain interval.

In this context, the invention provides a solution as an important innovation step. And this is to generate electricity (11, 12) in the generators (3, 4) actuated by gyroscopes and to discharge the produced energy to the space by radiation as heat energy (13). One or more heating panels (13) which will be placed on the external side of the spacecraft or built in the way to allow entrance and exit to inside and containing electricity will transfer this electricity to the space as radiation. During heat transfer by radiation, heat transfer is possible by means of the 4th force of temperature. In case that ceramic, graphite or metal resistances which are appropriate for high temperatures is used for the panel, very efficient heat transfer is possible in temperatures such as 2000 C. On the other hand, due the fact that the space is a vacuum environment, it will be easy to rise up to high temperatures as there will be no environment which will spoil these environments chemically either. This structure will remove the deceleration requirement by means of a rocket engine of vehicles such as space shuttles while approaching to the Earth. An increase in the beneficial load carried by the vehicle will be allowed.

In the system the speed of the gyroscopes can be controlled by controlling the magnetic area of the generators, for example by controlling currents or by means of methods such as approaching-departing between stator rotors. When the speed of the gyroscope is increased, its braking effect in the space will increase and when the speed of the gyroscope is decreased, its braking effect will decrease. Also the angle of the gyroscope shaft with the movement direction of the spacecraft can be used as an important parameter for controlling the braking effect.

The mechanism shown in FIG. 2 can be used during the vertical take off of air vehicles. In particular airplanes consume an important amount of energy and fuel in order to reach the flight height as from take off. Lifting a plane up to such a flight height of 12.000 m by means of such a platform by providing energy feed from the ground will dramatically decrease the fuel consumption and exhaust emission of airplanes.

In this type of lift-off, the attachment of the load to be carried can be done to two extensions extending to front and back in the system shown in FIG. 2. The load attachment will be done to the two extensions extending to front and back between the movement rails (not shown in the figure). Or two of the units shown in FIG. 2 will be used and the load will be attached in the middle of these two units. In this way an additional safety precaution would have been taken too. In case that one of the units breaks down, the lifting can be continued by the other one or a harmless slow landing can be performed.

1. A propulsion force generating method for a vehicle, comprising:
employing at least one gyroscope (1, 2) is being moved with a relative speed according to the vehicle,
moving these gyroscopes along a closed path periodically,
changing rotation axis of these gyroscopes during change of their movement direction,
obtaining a resistance force difference at the bearings of gyroscopes between forces involved during movement of gyroscopes in direction to the vehicle movement direction and during movement of said gyroscopes in the opposite direction,
employing said force difference as the propulsion force of the vehicle.

2. A vehicle propulsion method according to claim 1 further includes;
gyroscopes have electric motors that move along with themselves.

3. A vehicle propulsion method according to claim 1 further includes;
moving gyroscopic units and their motors along a closed railway constituting a closed curved path,
spinning rotation axis of these gyroscopes during turning movement direction of said gyroscopic units.

4. A vehicle propulsion method according to claim 1 further includes;
utilizing solar power panels using energy radiated by sun as the power source of said gyroscopic units.

5. A vehicle propulsion method according to claim 1 further includes;
employing frictionless magnetic bearing as the bearing of said gyroscopic units.

6. A vehicle propulsion method according to claim 1 further includes;
carrying a space vehicle to out of the atmosphere by employing said gyrocopic propulsion method.

7. A vehicle propulsion method according to claim 1 and claim 6 further includes;
employing rocket propulsion in order to accelerate space vehicle which was carried out of atmosphere after detaching gyroscopic propulsion system.

8. A vehicle propulsion method according to claim 1 and claim 4 further includes;
employing solar panels converting solar energy into electrical energy and employing a mechanism turning said panels toward the sun.

9. A vehicle propulsion method according to claim 1 further includes;
employing a turbine or internal combustion engine utilizing oxygen of the air as power source of said propulsion system during cruising in atmosphere.

10. A vehicle propulsion method according to claim 1 further includes;
feeding electricity to said propulsion system by connecting electric power from a source at the ground via conductor.

11. A vehicle propulsion method according to claim 1 further includes;
utilizing wind power in said propulsion system during cruising in the atmosphere.

12. A deceleration force generating method for a vehicle, comprising:
employing at least one gyroscope (1,2),
coupled said gyroscope to an electric motor/generator (3,4) to be driven,
generating a force in opposite direction of the movement by rotating gyroscope(s) and generating a deceleration in opposite direction of the movement,
converting torque generated at the gyroscope(s) into electric energy by said generator(s).
dissipating said energy to the space by converting electric energy into heat energy,
converting kinetic energy of the vehicle into heat energy dissipated to the space.

13. A system according to claim 12 further includes;
connecting said electric energy to the heat dissipating panel(s) including electric resistance(s) facing outer space, heating said panel(s) and dissipating energy to the space by radiation.

14. A system for controlling deceleration rate according to claim 12 ve claim 13 further includes;
changing magnetic field of generator driven by the gyroscope and/or,
changing angle between gyroscope rotation axis and movement direction and/or,
changing gyroscope rotation speed.
